(19) United States
(12) Patent Application Publication
(10) Pub. No.: US 2026/0080842 A1
(43) Pub. Date: Mar. 19, 2026

(54) LC DISPLAY RAMP AND RELAX TIMING

(71) Applicant: Snap Inc., Santa Monica, CA (US)

(72) Inventor: Aaron L. Boyce, Camas, WA (US)

(21) Appl. No.: 19/322,141

(22) Filed: Sep. 8, 2025

Related U.S. Application Data
(60) Provisional application No. 63/694,501, filed on Sep. 13, 2024.

(51) Int. Cl. G09G 3/36

(52) U.S. Cl. CPC G09G 3/3607; G09G 2300/0814; G09G 2320/0242; G09G 2320/0266; G09G 2320/0271; G09G 2320/0285; G09G 2320/064; G09G 2340/0435

(57) ABSTRACT

A display driver drives a color sequential liquid crystal display. The display driver obtains pixel intensity data for a pixel of the display, including a first color sub frame (CSF) pixel intensity value and a second CSF pixel intensity value for a second CSF following the first CSF. Selection logic is applied to the pixel intensity data to select a start time for a modulation pulse: for a given second CSF pixel intensity value, in response to a first first CSF pixel intensity value, a first start time is selected from a plurality of predefined potential start times; and in response to a second first CSF pixel intensity value greater than the first first CSF pixel intensity value, a second start time later than the first start time is selected. The liquid crystal material of the pixel is driven with a modulation pulse starting at the selected start time.

### CLAIM OF PRIORITY

This application claims the benefit of priority to U.S. Provisional Application Ser. No. 63/694,501, filed Sep. 13, 2024, which is incorporated herein by reference in its entirety.

### TECHNICAL FIELD

The present disclosure relates generally to liquid crystal display controls and more particularly to the timing of ramp and relax phases for pixels of liquid crystal displays.

### BACKGROUND

Liquid Crystal (LC) displays, such as color sequential Liquid Crystal on Silicon (LCoS) displays, are used in various applications due to their ability to provide high-quality images. Color sequential LCOS displays operate by rapidly cycling through multiple colors (typically red, green, and blue) in sequence to create full-color images. As display technology has advanced, there has been a growing demand for higher frame rates to improve motion performance and reduce artifacts.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1A shows an example analog control scheme applied to a pixel of an LC display during two consecutive color sub frames (CSFs) of a frame, according to some examples.

FIG. 1B shows the same frame as FIG. 1A governed by a first example digital control scheme, according to some examples.

FIG. 1C shows a different frame governed by the first example digital control scheme of FIG. 1B, according to some examples.

FIG. 2 shows a second example control scheme applied to a pixel of an LC display during two consecutive CSFs, according to some examples.

FIG. 3 shows a third example control scheme applied to a pixel of an LC display during two consecutive CSFs, according to some examples.

FIG. 4 shows an example long-ramp control scheme applied to a pixel of an LC display during two consecutive CSFs, according to some examples.

FIG. 5 is a block diagram of a display driver system, according to some examples.

FIG. 6 is a flowchart showing operations of a method for driving a color sequential liquid crystal display, according to some examples.

FIG. 7 shows an example calibrated long-ramp control scheme applied to a pixel of an LC display during two consecutive CSFs, according to some examples.

FIG. 8 is a flowchart showing operations of a method for calibrating a long-ramp control scheme for a color sequential LC display, according to some examples.

FIG. 9 shows a different frame governed by the calibrated long-ramp control scheme of FIG. 7, according to some examples.

FIG. 10 shows an example multi-pulse long-ramp control scheme applied to a pixel of an LC display during two consecutive CSFs, according to some examples.

FIG. 11 is a diagrammatic representation of a machine in the form of a computer system within which a set of instructions may be executed to cause the machine to perform any one or more of the methodologies discussed herein, according to some examples.

### DETAILED DESCRIPTION

An LCoS display works by using LC material applied to a reflective backplane. When an electric field is applied, the liquid crystals change their orientation, modulating the light that passes through them, and reflects off the silicon surface. Each pixel of an LCoS panel can be separately and independently stimulated by a circuit to operate LC pixels that can each be independently modulated. The modulated light from the pixels can then pass through a polarizer to create a desired image. In some examples, an LCoS display can use multiple LCoS panels, each paired with an emitter emitting light of a different color. The light reflected by the multiple LCoS panels can be combined to form a full-color image.

In a color sequential LCD (liquid crystal display), such as a color sequential LCoS display, instead of using a separate LCoS panel for each color, a single LC panel is used. The display rapidly cycles through activation and deactivation of red, green, and blue color emitters in sequence. During this cycling, the liquid crystal pixels of the single LC panel are controlled to modulate the light intensity for each color separately, in sequence. The human eye then integrates these quickly changing color images to perceive a full-color picture. The time period during a frame (corresponding to one full cycle) in which a given color of light is emitted and modulated by the LC panel is called a color sub frame (CSF): thus, a full frame of a color sequential display may include a red CSF, followed by a green CSF, followed by a blue CSF. A single frame may correspond to a single video frame rendered on the display; the terms “frame” and “cycle” may be used interchangeably herein refer to a time period encompassing a CSF for each color of emitter, unless otherwise indicated. The term “duty cycle”, as used herein, refers to a percentage or proportion of a frame occupied by a given CSF: for example, a single 8 ms frame or cycle may include a 2 ms red CSF, a 2 ms green CSF, and a 2 ms blue CSF, yielding a 25% duty cycle for each color.

As noted above, there is a demand for higher frame rates for color sequential LCDs, including color sequential LCoS displays, to improve motion performance and reduce artifacts. However, the inherent characteristics of LC materials present challenges when operating at higher frame rates. The response time of the LC, including both fall and rise times, affects the illumination gaps between CSFs during which the previous color emitter has been deactivated and the next color emitter has not yet been activated. These gaps are necessary to allow the LC to relax to the “off” state and then ramp up to the desired “on” state for each color. As frame rates increase, these gaps consume a larger percentage of the frame time, potentially reducing the available illumination duty cycle and, consequently, the brightness of the display. Additionally, the interaction between consecutive color sub-frames (CSFs) can lead to color errors and motion artifacts, particularly when rapid transitions between different intensity levels are required.

Color sequential LC displays require illumination gaps between CSFs for two main reasons. First, illumination gaps allow the LC to relax to the “off” state to prevent color bleed from a first CSF (e.g., red) into a subsequent second CSF (e.g., green) if none of the second color (e.g., green) is used for that pixel during the second CSF. Second, illumination gaps provide ramp time to get the LC to the “on” state before illumination is enabled, thus providing high efficiency for fully activated primary colors; for example, a pure green color is best displayed with the green emitter and the LC pixel fully active through the entire time period of the green CSF. The amount of time required for each of these is a result of the “response time” of the LC pixels, broken down into a fall time and a rise time. The response time of the pixels of a display is based on various factors, such as the LC chemical formulation, physical dimensions of the pixels, drive voltages, temperature, and so on. As the system frame rates increase (to provide better motion performance), these illumination gaps consume an increasing percentage of the frame time, thus reducing the available illumination duty cycle and thereby reducing the brightness of the display, which is in high demand.

For the highest image quality, each illumination gap would need to accommodate the full fall time followed by the full rise time. The fall time can be defined as the time the LC material takes to transition from a fully on (or nearly fully on, e.g., 90% on) state to the fully off (or nearly fully off, e.g., 10% on) state, which can differ between the different LCoS panels of the system used for different colors. Similarly, rise time can be defined as the time the LC material takes to transition from a fully off or nearly fully off state to a fully on or nearly fully on state, which can also vary based on color. In some examples, rise time is defined as the time to transition from 0% to 90% on, and fall time as the time to transition from 100% to 10% on. However, some examples described herein may shorten the illumination gap in order to increase display brightness. Illumination gaps of a sufficient duration to accommodate the full fall time and full rise time may be undesirable for most systems due to the resulting loss of maximum brightness, so some examples of display systems described herein achieve a compromise between image quality (requiring a long illumination gap) on the one hand, and higher brightness and/or increased frame rate (requiring a shorter illumination gap) by shortening the illumination gaps from the image quality maximizing duration, as will be shown below. Example drive schemes described herein may potentially be used with any type of LC display (including reflective and transmissive LC displays), using various types of modulation pulse alignment (e.g., leading edge, center, or ending edge aligned pulses).

Due to the factors described above, some systems exhibit a shorter fall time than rise time; some exhibit a shorter rise time than fall time; and some exhibit comparable fall times and rise times. Control logic controlling the LC displays provides a relax time during which an LC pixel is allowed to fall toward the off state, and a ramp time during which an LC pixel is driven toward the on state; these relax and ramp times aren't necessarily as long as the fall and rise times required to allow a transition from fully on to fully off and vice versa, due to the compromise between image quality and brightness referred to above.

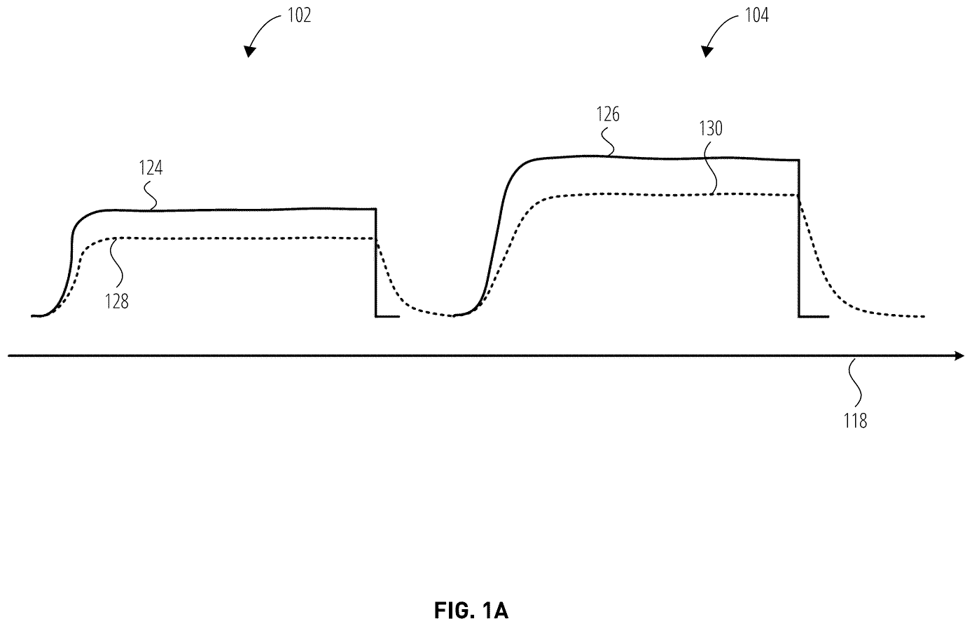

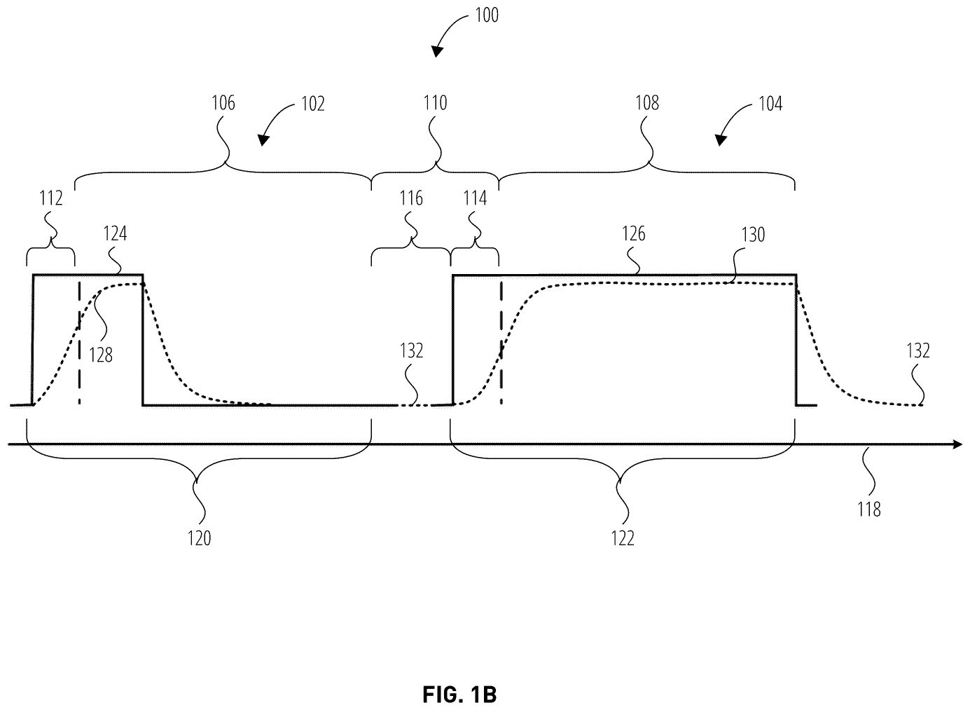

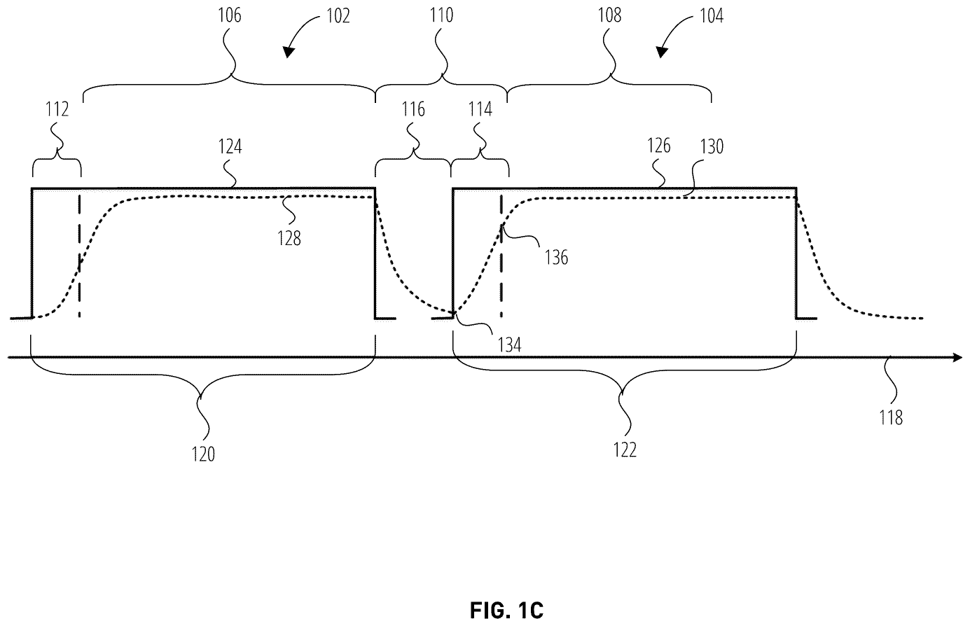

FIG. 1A shows a first example analog control scheme applied to a pixel of an LC display during two consecutive CSFs, a first CSF 102 followed in time 118 by a second CSF 104. In the analog control scheme, an analog voltage pulse ramps up voltage to drive the LC state to a desired level between fully off and fully on. For example, a first LC drive pulse 124 ramps up to a voltage levels suitable for maintaining a desired LC pixel state 128 during first CSF 102, and a second LC drive pulse 126 ramps up to a voltage levels suitable for maintaining a desired fully on state 130 during second CSF 104. This results in an intermediate pixel intensity value for first CSF 102, and a maximum pixel intensity value for second CSF 104.

FIG. 1B shows a first example control scheme 100 applied to a pixel of an LC display during two consecutive CSFs, a first CSF 102 (corresponding roughly to a first LC drive pulse 124 over a first modulation window 120) followed in time 118 by a second CSF 104 (corresponding roughly to a second LC drive pulse 126 over a second modulation window 122). The examples described herein will show pairs of consecutive CSFs; it will be appreciated that the principles governing these pairs of CSFs can be applied to any pair of consecutive CSFs, no matter where they occur within or across frames. The first example control scheme 100 and all subsequent control schemes described herein are shown as digital control schemes; however, it will be appreciated that some examples described herein can be applied in the context of analog control schemes, such as the example shown in FIG. 1A.

An LC pixel state 128 is modulated by the first example control scheme 100 over time 118; the LC pixel state 128 can correspond to a modulation state of the LC material of the pixel, such as transmittance of the LC pixel, thereby allowing a variable portion of the light from the active emitter to pass through an LC pixel of an LCoS display, reflect off the reflector, and pass back through the LC pixel to propagate toward a viewer. The first emitter emits during a first illumination window 106 of the first CSF 102 and the second emitter emits during a second illumination window 108 of the second CSF 104.

The first example control scheme 100 controls pixel brightness with respect to LC pixel modulation timing: in this example, the first relax time 116 at the end of the first CSF 102 is less than the fall time that would be required for the LC pixel state 128 to fall from a fully on state 130 to a fully off state 132, and the second ramp time 114 at the beginning of the second CSF 104 is only about half of the rise time required for the LC pixel state 128 to rise from a fully off state 132 to a fully on state 130. However, the combined relax and ramp times (e.g., first relax time 116 added to second ramp time 114) define the illumination gap 110 and are sufficient to provide the full fall time required by the pixel, assuming that the second CSF 104 can begin ramping up after the end of the second ramp time 114 or does not require activation of the LC material (e.g., due to a pixel intensity value of zero for the second CSF 104).

In the example first CSF 102 and second CSF 104 shown in FIG. 1B, the LC pixel state 128 during the first CSF 102 only briefly rises to the fully on state 130, indicating that the color used during the first CSF 102 (e.g., red) is not fully transmitted (e.g., the value of the pixel during this CSF is less than the maximum value). Thus, in this example, the LC pixel state 128 falls to the fully off state 132 long before the end of the first relax time 116. This means that the LC pixel state 128 needs to rise from the fully off state 132 at the beginning of the second CSF 104.

FIG. 1C shows a different frame governed by the first example control scheme 100 of FIG. 1B. In this frame, the first CSF 102 has a maximum color value for the first color (as used herein, the terms color value, pixel intensity, pixel value, and pixel intensity value can be used interchangeably to refer to an intensity value for a pixel during a CSF, such as a grayscale value ranging from 0 to 255, or a normalized grayscale value ranging from 0 to 1). This maximum color value requires the LC pixel state 128 to reach the fully on state 130 during the first CSF 102: this means that the first ramp time 112 is only about half as long as it needs to be to provide the required rise time (as already seen in second CSF 104 in FIG. 1B), and it also means that the LC pixel state 128 does not fully fall to the fully off state 132 during the first relax time 116. Instead, at the end of the first relax time 116, the LC pixel state 128 is only at a near-full off state 134 that is not the fully off state 132. This, in turn, means that the LC pixel state 128 begins rising during the second ramp time 114 from the near-full off state 134, allowing the LC pixel state 128 to reach a near-fully on state 136 by the end of the second ramp time 114.

What FIG. 1C illustrates is that, when the second color (used during the second CSF 104) is preceded by a bright first color (used during the first CSF 102), the ramp up to the second CSF 104 gets a head start, such that the LC pixel state 128 is nearly at its brightest state when the illumination is started.

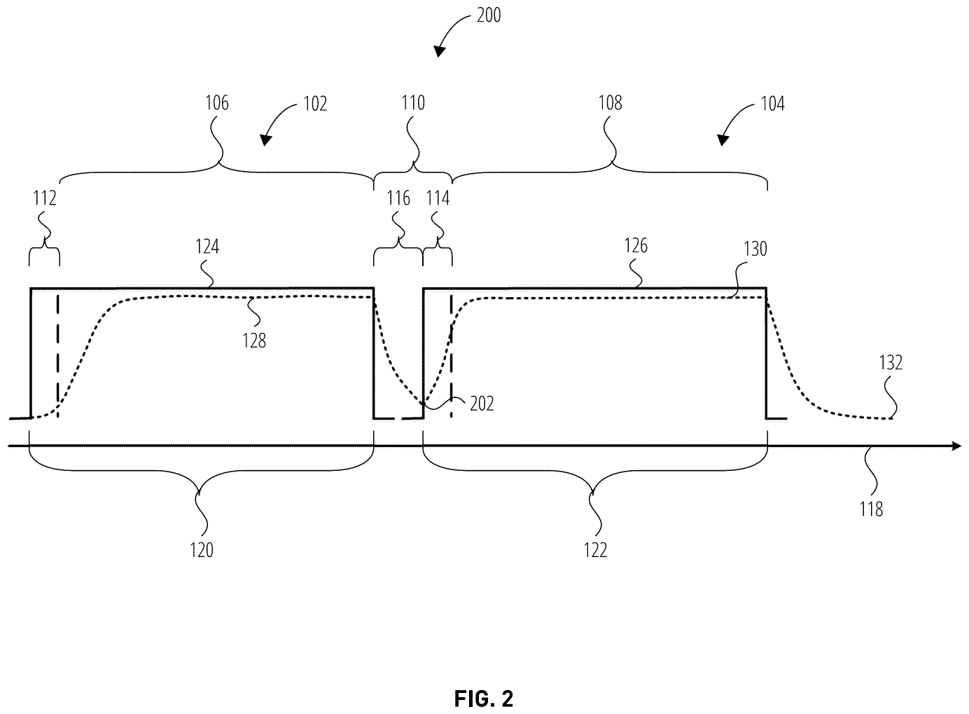

FIG. 2 shows a second example control scheme 200. In order to achieve faster frame rates and/or higher brightness, the second example control scheme 200 uses a relax time (such as first relax time 116) that is shorter than the fall time, followed by a very short ramp time (such as first ramp time 112 and second ramp time 114) that is much shorter than the rise time. In the second example control scheme 200, the illumination gap 110 is set to approximately the fall time. This avoids color bleed into black (caused by a high color value during the first CSF 102 followed by a low color value during the second CSF 104), but it intentionally uses the color bleed into white (e.g., the incomplete fall of the LC pixel state 128 from the fully on state 130 to a partially off state 202 higher than the near-full off state 134 of FIG. 1C) to get higher efficiency, due to the ability of the LC pixel state 128 to rise from the partially off state 202 nearly to the fully on state 130 during the relatively short second ramp time 114.

While potentially achieving high brightness and high frame rates, the second example control scheme 200 can give rise to unwanted effects. Motion artifacts and reduced efficiency can manifest when the color value of the first CSF 102 is low, thereby providing no bleed into second CSF 104 to give the LC pixel state 128 a head start on ramping up. The motion artifacts can be described as either of two types. Late pixel fringes, also referred to as dark shadows, are dim regions of the image caused by a bright feature moving to an area on the display that was previously black; the dimness occurs because the pixels previously-dark have a longer rise time. The second type of motion artifact, referred to as bright shadows, are caused when a bright feature moves away from an area and is replaced with a dim fill color, causing the dim color to be magnified due to bleed from the previous bright color.

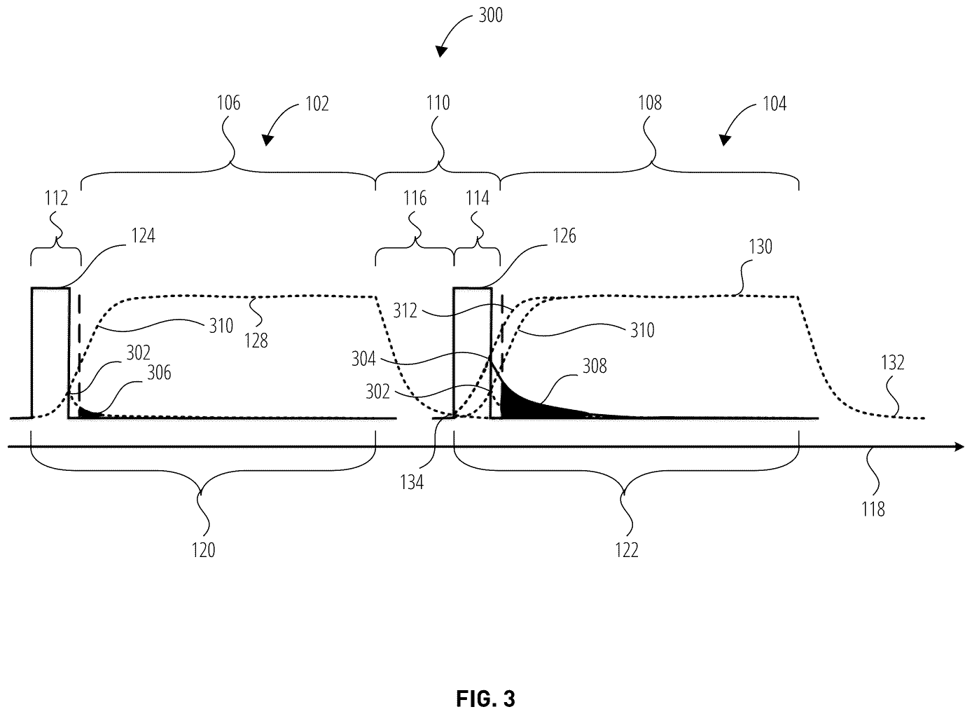

FIG. 3 shows a third example control scheme 300. The third example control scheme 300 is intended to account for a rising-edge-aligned pulse width modulation (PWM) drive scheme for the LC display.

PWM drive schemes can align their modulation pulses using one of several alignment schemes, such as rising edge (also called left-edge or leading edge), center, or falling edge (also called right-edge or ending-edge) alignment. In some cases, LCoS pixel modulation exhibits certain limitations when using center aligned PWM. Accordingly, in some examples, all LC drive modulation level pulses (such as the first LC drive pulse 124 for all pixels of the display, and the second LC drive pulse 126 for all pixels of the display) share the same rising edge event at the start of the modulation window (such as first modulation window 120 or second modulation window 122, respectively).

In a rising-edge-aligned PWM drive scheme, low intensity colors may have a short modulation pulse that can end even before illumination begins. These short pulses are even more affected by the ending state of the previous CSF.

FIG. 3 shows multiple possible trajectories for the LC pixel state 128 in each CSF. During the first CSF 102, the LC pixel state 128 begins rising from a cold start in which the LC pixel state 128 is in the fully off state 132. The LC pixel state 128 begins to follow a cold start trajectory 310 during the first ramp time 112. However, because the first LC drive pulse 124 is so short due to the low color value for the first CSF 102, the LC pixel state 128 stops rising very early, achieving only a low peak state 302 before beginning to fall again. This fall begins even before the start of the first illumination window 106: by the time the emitter begins emitting at the start of the first illumination window 106, only a small area 306 under the graph of the LC pixel state 128 falls within the first illumination window 106, indicating a very small amount of light (also referred to as luminance) actually transmitted or reflected by the LC pixel.

The same behavior would be true of the second CSF 104 if it were to start from a cold start at the fully off state 132, as shown by the cold start trajectory 310 of the second CSF 104. However, if the previous CSF (first CSF 102 in this example) used a high color value, the LC pixel state 128 would not fully relax, such that the first CSF 102 could begin in a figuratively “warmed up” state: the near-full off state 134, instead of the fully off state 132. This warmed up starting state would give rise to the warmed up trajectory 312 shown in second CSF 104, which rises to the higher peak state 304 before beginning to fall. Even though the second LC drive pulse 126 has the same width as first LC drive pulse 124, indicating that both CSFs are intended to have the same color values, the cold start of the first CSF 102 relative to the warmed up start of the second CSF 104 means that the second CSF 104 has larger area 308 under the LC pixel state 128 curve within the second illumination window 108, resulting in a much higher amount of light being propagated from the pixel (e.g., higher luminance of the pixel) than small area 306 in first CSF 102. Thus, second CSF 104 would exhibit a much brighter or higher pixel luminance than first CSF 102 even though both are intended to have the same color value and are driven by the same LC modulation level pulse width (e.g., first LC drive pulse 124 and second LC drive pulse 126).

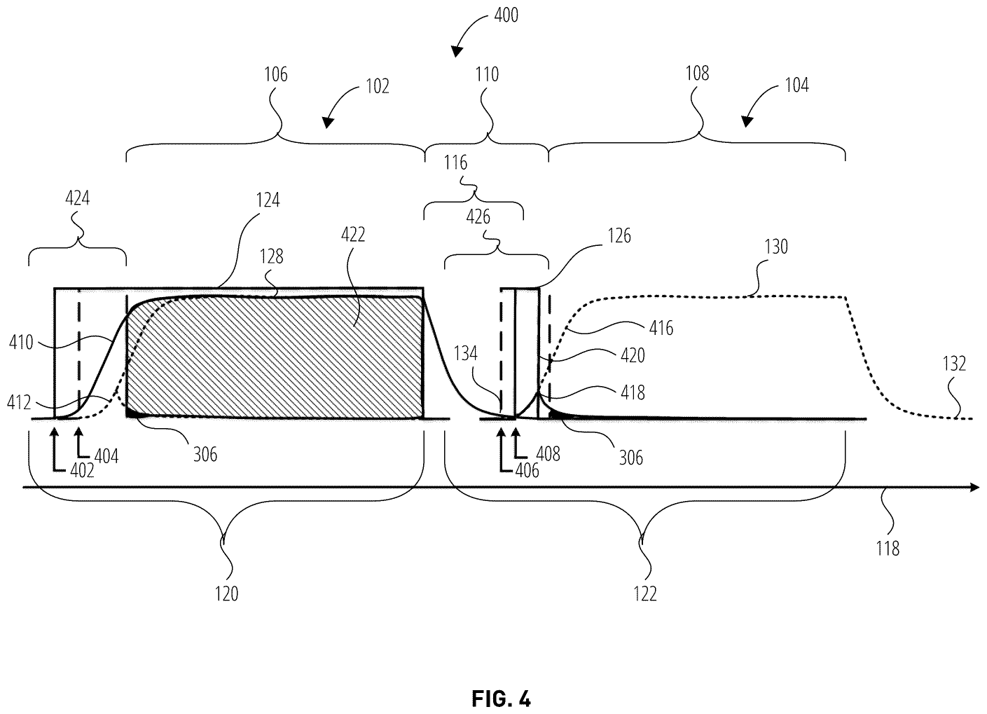

FIG. 4 shows a long-ramp control scheme 400. The long-ramp control scheme 400 addresses one or more of the limitations encountered by other control schemes for color sequential LC displays, such as first example control scheme 100, second example control scheme 200, or third example control scheme 300.

The long-ramp control scheme 400 can be configured in accordance with one or more of the following three principles: 1) that the relax window and the ramp window can be overlapped, but not for the same pixel; 2) that there are multiple opportunities for the timing of a rising edge within the ramp time of a CSF (such as second CSF 104); and 3) that the control scheme can select among these multiple rising edge opportunities based on both the pixel intensity (e.g., color value) of the current CSF (e.g., second CSF 104) and the pixel intensity (e.g., color value) of the previous CSF (e.g., first CSF 102).

The illumination gap 110 in the long-ramp control scheme 400 is sized according to the larger of the fall time or the rise time of the pixels of the display. For example, if first CSF 102 has a maximum color value (e.g., a 1 or white value in which the LC pixel state 128 rises to the fully on state 130 during first CSF 102) and second CSF 104 has a minimum color value (e.g., a 0 or black value in which the LC pixel state 128 occupies the fully off state 132), then there should be no color bleed, because the illumination gap 110 is at least the duration or width of the fall time, allowing the LC pixel state 128 to fall from the fully on state 130 to the fully off state 132 before the second illumination window 108. Similarly, if first CSF 102 has a minimum color value and second CSF 104 has a maximum color value, the LC pixel state 128 can rise from the fully off state 132 to the fully on state 130 before the second illumination window 108 begins, because the illumination gap 110 is at least the width of the rise time.

As referred to above with reference to third example control scheme 300, the use of center aligned modulation for LCoS displays can give rise to visual artifacts around bright intensity pixels, referred to as fringe field banding, due to the large differences between the rising modulation time of adjacent pixels. However, if the difference in start times is relatively small, the impact can be kept at an acceptably small level. Thus, the long-ramp control scheme 400 can be configured to maintain the timing of rising edges of different pixels close together in time within a ramp window.

In some examples, the long-ramp control scheme 400 is implemented using a driver circuit, such as an application specific integrated circuit (ASIC) having a look up table (LUT) or other reference data stored or encoded in its logic to select rising edge times for beginning of the second LC drive pulse 126 of the second CSF 104 based on the pixel intensity values of the first CSF 102 and the second CSF 104. In some examples, an 8-bit LUT is used to look up or select a rising edge timing (also referred to as a rising modulation event or a start time for the modulation pulse) based on a 4-bit encoding of the first CSF 102 pixel intensity value and a 4-bit encoding of the second CSF 104 pixel intensity value. In some examples, the 4-bit encodings of the pixel intensity values is obtained by reading the four (or fewer) most significant bits of a longer binary encoding of a given pixel intensity value, such as the 4 most significant bits of an 8-bit binary encoding of a grayscale value ranging from 0 to 255.

The rising edge timing defines the beginning of the second LC drive pulse 126. The falling edge timing (also referred to as the ending modulation event or an end time for the modulation pulse), which defines the end of the second LC drive pulse 126, can be selected according to existing PWM techniques, and may be unmodified by the LUT; in some examples, the greater the pixel intensity of the second CSF 104, the later the falling edge, such that a maximum pixel intensity results in a falling edge at the end of the second modulation window 122.

The rising edge of the second LC drive pulse 126 can fall anywhere within the second ramp start window 426, providing a ramp time that is potentially much longer than in the other example control schemes, and is therefore capable of encompassing the full rise time (which is only needed for the brightest intensity values for the second CSF 104). Because of this, the second LC drive pulse 126 for a high pixel intensity can be started earlier and the second LC drive pulse 126 for a low pixel intensity is started later within the second ramp start window 426, thereby providing a longer first relax time 116 at the end of the first CSF 102. Another consequence of the long second ramp start window 426 is that dim pixel values for the second CSF 104 should not begin ramping up (e.g., second LC drive pulse 126 should not begin) too early in the second ramp start window 426, because there is a risk that the short second LC drive pulse 126 would end before the last opportunity for a rising edge; this can impose limitations or unnecessary constraints when calibrating the system, because the selection of the rising edge timing would need to exclude any timing opportunities coming after the end of the second LC drive pulse 126. Thus, the same portion of the illumination gap 110 (e.g., the portion falling within the second ramp start window 426) can be used as ramp time for a second CSF 104 having a bright pixel intensity value, and can be used as relax time for a second CSF 104 having a dim pixel intensity value.

As in FIG. 3, FIG. 4 shows multiple different overlapping scenarios for the first CSF 102 and the second CSF 104. A primary example is shown by the solid lines for the LC pixel state 128; secondary examples are shown by the dashed lines.

In the illustrated example, the LC pixel state 128 is driven to the fully on state 130 during the first CSF 102. The first LC drive pulse 124 in this example begins at an earlier rising edge timing 402 (selected from the multiple rising edge opportunities described above), thereby causing the LC pixel state 128 to follow an earlier trajectory 410. This example assumes that the CSF prior to the first CSF 102 had a low pixel value, allowing the LC pixel state 128 to fully relax before the earlier rising edge timing 402. When the first illumination window 106 begins, the LC pixel state 128 is nearly at the fully on state 130 due to its early start at the earlier rising edge timing 402, resulting in very high total illumination during the first CSF 102 shown by the shaded maximum area 422.

After the first illumination window 106 and first modulation window 120 end, and the LC pixel state 128 begins to relax during the first relax time 116, a rising edge timing must be selected for the second CSF 104. In this primary example, a later rising edge timing 408 is selected to allow the LC pixel state 128 enough time to fully relax. This results in second LC drive pulse 126, which is a short pulse because the pixel intensity value for the second CSF 104 is low. Beginning the second LC drive pulse 126 at later rising edge timing 408 causes the LC pixel state 128 to follow the later trajectory 416, and the LC pixel state 128 only achieves a low peak state 418 by the end of the short second LC drive pulse 126, after which it begins to fall. When the second illumination window 108 begins, the nearly off state of the LC pixel state 128 results in only the small area 306 under the curve, corresponding to a very small amount of total illumination during the second CSF 104.

Alternatively, in some cases, the second LC drive pulse 126 can be a wide pulse (e.g., for a maximum pixel intensity value), driving the LC pixel state 128 to the fully on state 130 and resulting in a maximum illumination comparable to the maximum area 422 for the first CSF 102 in the primary example. The time during the second illumination window 108 when the LC material is fully on can be increased by selecting the earlier rising edge timing 406 instead of the later rising edge timing 408.

Thus, it will be appreciated that the rising edge timing for a given CSF can be selected based on the pixel intensity value of a previous CSF as well as the pixel intensity value of the current CSF. For example, the system can be configured to select between earlier rising edge timing 406 and later rising edge timing 408 for the second CSF 104 based in part on the previous CSF's pixel intensity value: a low previous CSF pixel intensity value means that no relax time is needed, so the earlier rising edge timing 406 can be safely selected, whereas a high previous CSF pixel intensity value requires a long relax time, requiring that the later rising edge timing 408 be selected. In addition, the selection between earlier rising edge timing 406 and later rising edge timing 408 for the second CSF 104 is based in part on the current CSF's pixel intensity value: a high current CSF pixel intensity value means that more ramp time is needed, so the earlier rising edge timing 402 should be selected, whereas a low current CSF pixel intensity value may be implemented using either the earlier rising edge timing 406 or later rising edge timing 408 depending on various factors. In some examples, the earlier rising edge timing 406 cannot be selected for some short pulse widths of the second LC drive pulse 126, because it would result in the second LC drive pulse 126 ending before the last rising edge timing opportunity. In some examples, selection of the later rising edge timing 408 results in significant relaxation before the beginning of the second illumination window 108, resulting in very low illumination (shown by the small area 306 in the second illumination window 108 of the primary example). In some examples, selection of the earlier rising edge timing 406 results in less relaxation before the beginning of the second illumination window 108, resulting in more illumination during the second illumination window 108, as shown by the area under the LC pixel state 128 curve following the higher peak state 420 of the secondary example.

It will be appreciated that, in leading edge aligned control schemes, all possible rising edge timing opportunities or options are confined to the ramp window, such as first ramp start window 424 for first CSF 102 or second ramp start window 426 for second CSF 104. This means that pulses never start near the center or right side of the illumination window, as can happen in a center-aligned or falling-edge-aligned PWM scheme. Instead, the pulses applied to different pixels during a given CSF all have rising edges that only differ from each other by a small duration, thereby addressing the technical limitation addressed by the third example control scheme 300 described above and avoiding significant fringe field banding. In some examples, center-aligned or ending-edge-aligned control schemes can also use this approach while also reducing visual artifacts, particularly if the modulation resolution is very fine and there are multiple opportunities to make small adjustments to the pulse widths in the middle or end of the modulation window.

In some examples, the use of dynamically configurable ramp time and relaxation time windows with temporal ranges that overlap each other within the frame can be used to address the technical problem of sequential color error. Color values can be altered as a result of the LC state during a previous CSF; thus, a drive scheme in which the start time of a second CSF is not adjusted based on the intensity value of the prior CSF can result in the amount of the second color of light varying based on the pixel intensity of the prior color of light. For example, a control scheme using a red-blue-green sequence of CSFs for each frame will tend to emit more blue light than intended when red values are high than when red values are low. This means that certain non-primary colors will not display as intended: for example, red colors will include more blue light than intended, potentially giving them a more purple hue. The long-ramp control schemes described herein can correct these sequential color errors at the level of the display itself, potentially in addition to one or more of the other advantages described herein.

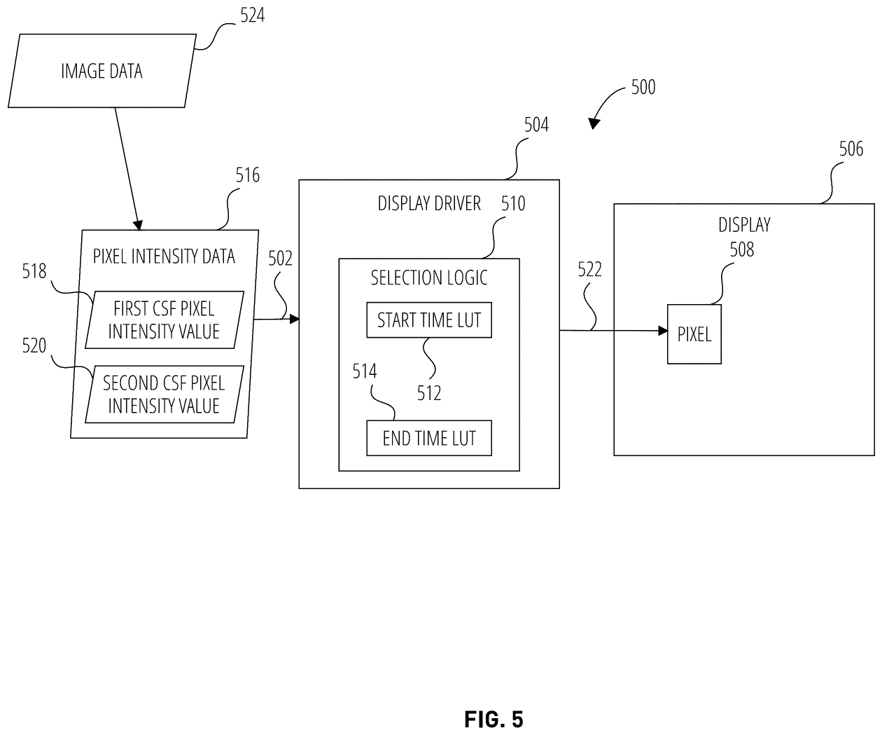

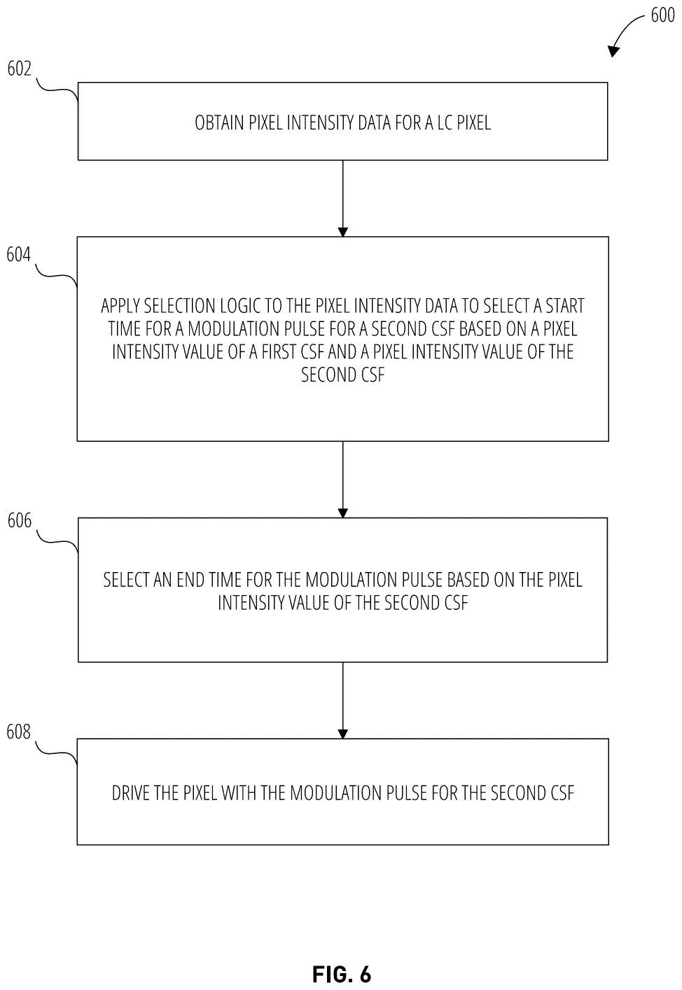

The long-ramp control scheme 400, or other control schemes described herein, can be implemented by a display driver device or system. An example display driver device or system is described below with reference to FIG. 5. Operation of the display driver device or system is described with reference to an example method described below with reference to the flowchart of FIG. 6.

FIG. 5 shows a block diagram of a display driver device or system, shown as system 500 including display driver 504. The operation of the display driver 504 and system 500 are described with reference to the operations of method 600 shown in FIG. 6.

FIG. 6 illustrates an example method 600 for driving a color sequential liquid crystal display. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

According to some examples, the method 600 includes obtaining pixel intensity data 516 for a LC pixel 508 at operation 602. The display driver 504 is configured to receive pixel intensity data 516 (e.g., via an input 502) and process the pixel intensity data 516 to drive a color sequential LC display 506, such as a color sequential LCoS display having an LCoS panel. The pixel intensity data 516 received by the display driver 504 can include, or can be derived from, pixel intensity data for each of multiple pixels of the display 506. For example, image data 524 can be received encoding color values for each pixel over one or more frames. The color value of the pixel for the current frame (e.g., a single RGB value) can be extracted and translated into three separate pixel intensity values, one for each CSF of the frame.

The pixel intensity data 516 can be received from a host system, such as from a GPU of a computer system (not shown). In some examples, the pixel intensity data 516 includes, for each pixel 508 of the display 506, a pixel intensity value for a first CSF (e.g., first CSF 102), shown as first CSF pixel intensity value 518, and a pixel intensity value for a second CSF (e.g., second CSF 104) following the first CSF, shown as second CSF pixel intensity value 520. The first CSF and second CSF can be consecutive within a single frame, or consecutive across a boundary between two consecutive frames.

According to some examples, the method 600 includes applying selection logic 510 to the pixel intensity data 516 to select a start time for a modulation pulse 522 for the second CSF based on the first CSF pixel intensity value 518 and the second CSF pixel intensity value 520 at operation 604.

For each pixel 508 being driven, the display driver 504 applies selection logic 510 to the pixel intensity data 516 for that pixel 508 to select a start time for a modulation pulse 522 to be applied to liquid crystal material of the pixel 508. In some examples, the selection logic 510 includes a LUT for selecting the start time, such as an 8-bit LUT as described above, shown as start time LUT 512. The selection logic 510 operates according to one or more of the long-ramp control schemes described herein, such as long-ramp control scheme 400, to select the start time based on the first CSF pixel intensity value 518 and the second CSF pixel intensity value 520. In some examples, for a given second CSF pixel intensity value 520, the selection logic 510 will select a later start time in response to a high first CSF pixel intensity value 518 than in response to a low first CSF pixel intensity value 518. However, as described herein, the selection logic 510 may base its selection of the start time at least in part on the second CSF pixel intensity value 520 as well as the first CSF pixel intensity value 518.

According to some examples, the method 600 includes selecting an end time for the modulation pulse 522 based on the second CSF pixel intensity value 520 at operation 606. The end time can be selected in some examples using an end time LUT 514 of the selection logic 510. In some examples, the end time can also be adjusted in conjunction with the start time adjustment using the pixel intensity data for both the first CSF 102 and second CSF 104 (e.g., first CSF pixel intensity value 518 and second CSF pixel intensity value 520).

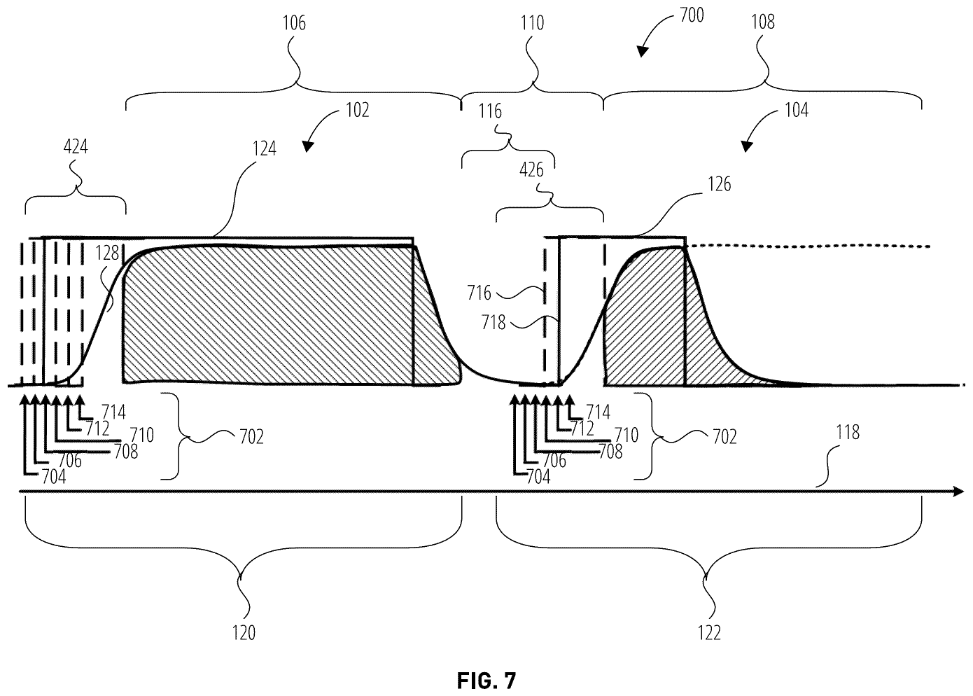

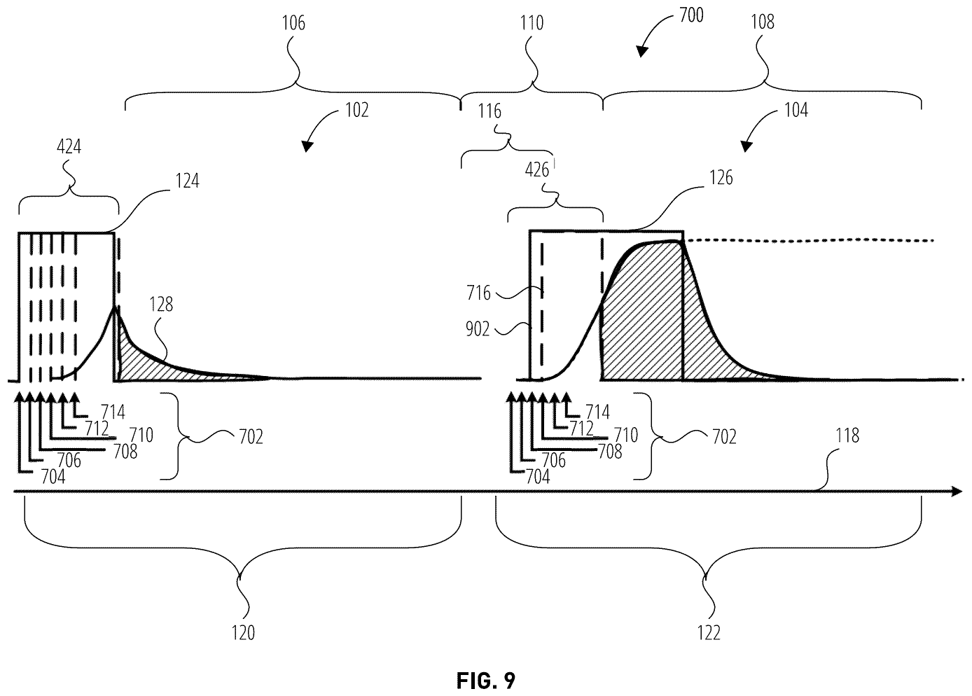

As described above, in some examples, the end time for the modulation pulse 522 is determined or selected without regard to the first CSF pixel intensity value 518, and is based entirely on the second CSF pixel intensity value 520. Further details of some such example control schemes, and calibration of such example control schemes, are described below with reference to FIG. 7 and FIG. 9. In some examples, the display driver 504 selects from a plurality of predetermined potential end times based on the second CSF pixel intensity value 520, the plurality of predetermined potential end times being defined using PWM techniques for achieving a desired luminance. For example, the end time can be selected to be a time during the second ramp start window 426 or the second illumination window 108, and the end time can be later for high pixel intensity values than for lower pixel intensity values. It will be appreciated, however, that the luminance propagated by pixels having a low pixel intensity value can be highly variable if an early start time is selected and the end time occurs during the second ramp start window 426, thereby giving rise to at least some amount of relaxation prior to the second illumination window 108, as shown in the second CSF 104 of FIG. 4. Thus, low pixel intensity values may require calibration to ensure that the luminance propagated by the pixel is a close match to the desired luminance for the pixel intensity value. Examples of such a calibration process are described below with reference to FIG. 7 and FIG. 9.

According to some examples, the method 600 includes driving the pixel 508 with the modulation pulse 522 for the second CSF at operation 608.

After the start time and end time of the modulation pulse 522 have been determined, the display driver 504 drives (e.g., using pixel driver circuitry, not shown) the liquid crystal material of the pixel 508 with a modulation pulse 522 (e.g., a voltage pulse applied by a pixel electrode) starting at the selected start time.

As described above, the display 506 can be any suitable color sequential liquid crystal display, such as a color sequential LC display using an LCoS panel and a plurality of emitters, wherein each emitter emits light of a respective color during a respective CSF of the frame.

In some examples, the method 600 is performed for each pixel of the display 506, or for each of a plurality of pixels of the display 506. The display driver 504 can be a circuit (such as a display backplane or ASIC) configured to perform method 600 for each of multiple pixels in parallel. Thus, method 600 is performed for a first pixel 508 to determine and apply a first modulation pulse 522 having a first start time and a first end time, and method 600 is performed, concurrently or subsequently, for a second pixel to determine and apply a second modulation pulse having a second start time and a second end time which may differ from the start time and/or end time of the first modulation pulse 522.

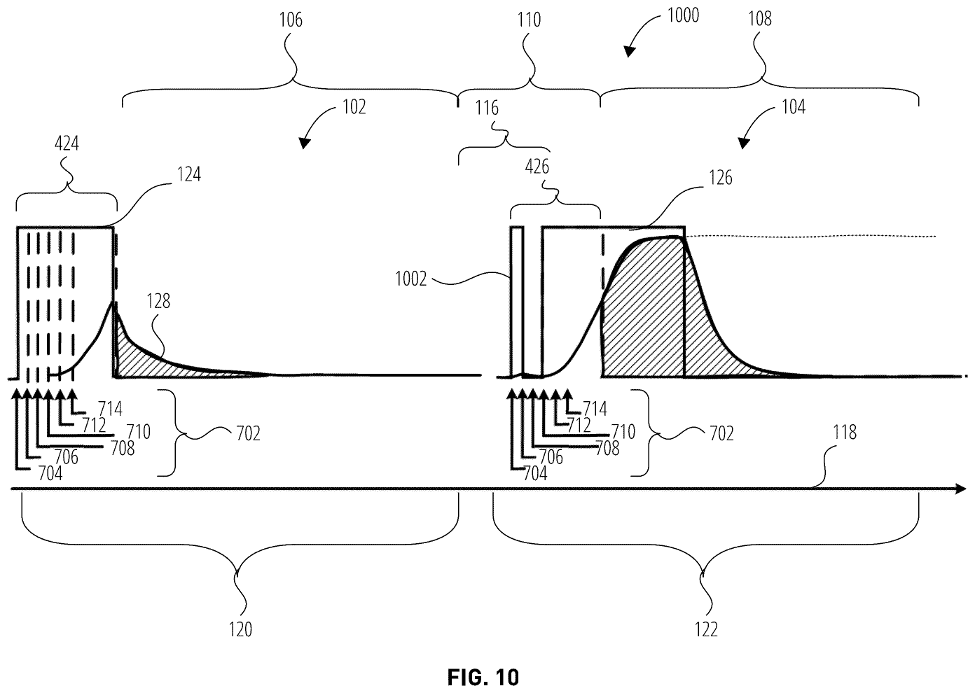

It will be appreciated that some modulation control schemes use more than one pulse, such as the example described below with reference to FIG. 10. In some such examples, the shaping of the pulses may involve more selection logic than simply selection of a single start time and a single end time.

FIG. 7 shows an example of how to define a plurality of predefined potential start times 702 for each CSF, and how to calibrate the selection logic to select from among the predefined potential start times based on the pixel intensity value of the first CSF 102 and the pixel intensity value of the second CSF 104.

In this example, six potential start times are included in the plurality of predefined potential start times 702 for a given CSF: first potential start time 704, second potential start time 706, third potential start time 708, fourth potential start time 710, fifth potential start time 712, and sixth potential start time 714.

As described above with reference to long-ramp control scheme 400, each predefined potential start time of the plurality of predefined potential start times 702 falls within a ramp start window of the CSF (e.g., second ramp start window 426 of second CSF 104). For a leading edge aligned control scheme such as 400, the ramp start window ends no later than a start time of an illumination window of the CSF (e.g., second illumination window 108 of the second CSF 104) during which an emitter illuminates the pixel. However, it will be appreciated that come center-or ending-edge-aligned control schemes may use a ramp window that permits some of the plurality of predefined potential start times 702 to fall later than the beginning of the illumination window.

As shown in FIG. 7, the plurality of predefined potential start times 702 for the first CSF 102 is the same as the plurality of predefined potential start times 702 for the second CSF 104. However, in some examples, the plurality of predefined potential start times 702 used for a CSF of a first color (e.g., a red CSF) can differ from the plurality of predefined potential start times 702 used for a CSF of a second color (e.g., a green or blue CSF) in order to account for differences between the different color emitters, the interaction of the LC material with different wavelengths of light, and/or other factors. Thus, in some examples, the plurality of predefined potential start times 702 for a given CSF is based at least in part on a color of the given CSF.

In some examples, the number of predefined potential start times included in the plurality of predefined potential start times 702 can be relatively low. For example, some long-ramp control schemes can use only four predefined potential start times, such that the selection of a predefined potential start time can be encoded in two bits, and a relatively small start time LUT 512 can be used in the selection logic 510. However, some examples, such as the example shown in FIG. 7 having six predefined potential start times, can use a relatively larger number of predefined potential start times in order to assist in calibrating the control scheme to correct for residual error in the desired luminance resulting from a given pixel intensity value. In some examples, the complexity of the start time LUT 512 or other selection logic is the main constraint on the number of different predefined potential start times that can be employed, whereas some examples may exhibit additional constraints on the number of different predefined potential start times.

In some examples, the plurality of predefined potential start times 702 is placed close together in time 118 within the ramp start window (e.g., first ramp start window 424 or second ramp start window 426). This close placement allows fine-grained selection of start times to assist in calibration, as described below, and can also minimize the risk of fringe field banding.

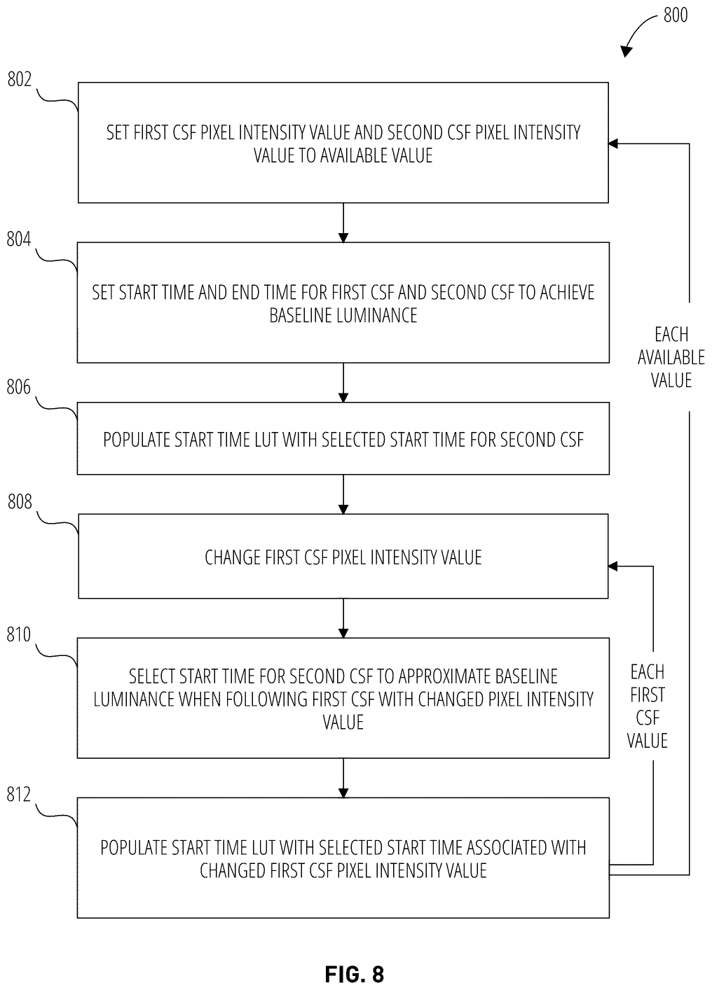

Calibration of the control scheme can be performed to populate the LUT with an appropriate start time for each combination of first CSF pixel intensity value 518 and second CSF pixel intensity value 520. An example calibration method 800 is described with reference to the flowchart of FIG. 8.

FIG. 8 illustrates an example method 800 for calibrating a long-ramp control scheme for a color sequential LC display. Although the example method 800 depicts a particular sequence of operations, the sequence may be altered without departing from the scope of the present disclosure. For example, some of the operations depicted may be performed in parallel or in a different sequence that does not materially affect the function of the method 800. In other examples, different components of an example device or system that implements the method 800 may perform functions at substantially the same time or in a specific sequence.

The calibration method 800 is performed for each available pixel intensity value (or for each truncated pixel intensity value, e.g., a 4-bit re-encoding of an 8-bit grayscale value).

According to some examples, the method 800 includes setting the first CSF pixel intensity value (e.g., first CSF pixel intensity value 518) and the second CSF pixel intensity value (e.g., second CSF pixel intensity value 520) to the current available value at operation 802.

According to some examples, the method 800 includes setting a start time and an end time for each of the first CSF and second CSF in order to achieve a baseline luminance at operation 804. In some examples, the baseline luminance is calibrated using PWM techniques to set a desired width for the modulation pulse, which is a function of the start time and the end time. The baseline luminance, and the start times and end times associated therewith, are defined with respect to the baseline scenario of operation 802, in which the first CSF 102 and second CSF 104 both have the same pixel intensity value.

According to some examples, the method 800 includes populating the start time LUT 512 with the selected start time for the second CSF 104 at operation 806. The start time for the baseline scenario is unchanged by later calibration operations; therefore, the entry in the LUT for the baseline scenario can be populated. In some examples, an end time LUT 514 can also be populated with the selected end time.

According to some examples, the method 800 includes changing the first CSF pixel intensity value 518 at operation 808. The intensity of the previous CSF is perturbed in order to observe how this changes the luminance of the current CSF, and to adjust the start time for the current CSF in this scenario if necessary.

According to some examples, the method 800 includes selecting a start time for the second CSF 104 to approximate the baseline luminance when following the first CSF 102 with its newly changed pixel intensity value (e.g., first CSF pixel intensity value 518) at operation 810. In some examples, a start time is selected for the second CSF 104 such that the driving of the liquid crystal material of the pixel with a modulation pulse 522 having this selected start time results in a luminance of the pixel during the second CSF 104 that is closer to the baseline luminance than a luminance resulting from the selection of any of the other predefined potential start times of the plurality of predefined potential start times 702. In other words, the start time option that results in a luminance that best matches the desired baseline luminance is the start time option that should be selected. Operation 810 can be performed by sequentially selecting each available predefined potential start time, and testing the luminance of each resulting iteration of the second CSF 104 following the first CSF 102, then selecting the predefined potential start time that satisfies the selection criterion by providing a closest match to the baseline luminance.

According to some examples, the method 800 includes populating the start time LUT 512 with the selected start time associated with the changed first CSF pixel intensity value 518 at operation 812.

Operation 808 through operation 812 can then be repeated for each available first CSF pixel intensity value 518, resulting in population of all LUT entries for the current second CSF pixel intensity value 520.

The method 800 can then return to operation 802 to repeat method 800 for a second available pixel intensity value, and for each other available pixel intensity value, until all entries of the LUT are populated.

This method 800 results in selection logic 510 configured, for any given second CSF pixel intensity value 520, to select the start time for the second LC drive pulse 126 such that the driving of the liquid crystal material of the pixel 508 with the modulation pulse 522 results in a luminance of the pixel 508 during the second CSF 104 that is closer to the baseline luminance than a luminance resulting from the selection of any other predefined potential start time of the plurality of predefined potential start times 702. The long-ramp control scheme is then be considered to be calibrated, and can provide a consistent pixel intensity for the current CSF value, regardless of the previous CSF value. In some examples, the control scheme can be calibrated to account for multiple parameters, including pulse widths varying from frame to frame, for a given pixel intensity, such that the “average luminance” over multiple frames is matched by selecting a best fit start time for each frame for the matching color CSF and account for the best fit for all new start times combined.

Returning to FIG. 7, a first example is shown of the operation of a calibrated long-ramp control scheme 700. The first CSF 102 exhibits a high first CSF pixel intensity value 518, whereas the second CSF 104 exhibits a mid-range second CSF pixel intensity value 520. Because of the high first CSF pixel intensity value 518 in first CSF 102, the calibrated long-ramp control scheme 700 delays the start time of the second LC drive pulse 126 from a baseline start time 716 at fourth potential start time 710 to a delayed start time 718 at fifth potential start time 712, in order to leave time for the LC pixel state 128 to relax.

FIG. 9 shows a second example of the operation of the calibrated long-ramp control scheme 700. In contrast to the scenario of FIG. 7, in FIG. 9, the first CSF 102 has a low first CSF pixel intensity value 518, such that the LC pixel state 128 is fully relaxed by the end of the first CSF 102. This allows the calibrated long-ramp control scheme 700 to select an earlier start time for the second LC drive pulse 126, advancing the start time from baseline start time 716 at fourth potential start time 710 to advanced start time 902 at third potential start time 708.

As described above, the ideal number of steps to adjust (e.g., delay or advance) the star time from a baseline start time can be calculated based on calibration, e.g., by method 800. The calibration method 800 can be performed using either simulated or modeled LC state and luminance data, or empirically collected experimental test data. The modeled or empirically measured results of each adjustment of the start time can be compared to the baseline luminance, which can be a gamma calibrated condition. The start time that provides the closest match to the gamma calibrated baseline luminance can then be selected, and that selection can be stored or encoded in the LUT in association with the given first CSF pixel intensity value 518 and second CSF pixel intensity value 520.

FIG. 10 shows an example of the operation of a multi-pulse long-ramp control scheme 1000. In some examples, the long-ramp control scheme 400, calibrated long-ramp control scheme 700, or another long-ramp control scheme can be further modified to include the capability of applying multiple modulation pulses within a single ramp start window (e.g., second ramp start window 426). In the example shown in FIG. 10, a pre-emphasis modulation pulse 1002 is used to drive the LC pixel state 128 early in the second ramp start window 426. The residual decay of the LC pixel state 128 from the pre-emphasis modulation pulse 1002 can serve to bolster the trajectory of the LC pixel state 128 during the second LC drive pulse 126. Thus, the pre-emphasis modulation pulse 1002 can be used in some examples as a half-step or partial step between two adjacent predefined potential start times, such that the number of predefined potential start times can be effectively increased (e.g., doubled) by selecting each predefined potential start time with or without a pre-emphasis modulation pulse 1002.

Thus, in some examples, the selection logic 510 further includes logic for determining, based on the first CSF pixel intensity value 518 and the second CSF pixel intensity value 520 of the pixel intensity data 516, to further apply a pre-emphasis modulation pulse 1002 to the liquid crystal material of the pixel 508. If a pre-emphasis modulation pulse 1002 is determined to be necessary, the display driver 504 drives the liquid crystal material of the pixel 508 with the pre-emphasis modulation pulse 1002. The pre-emphasis modulation pulse 1002 is timed to end before the selected start time for the second LC drive pulse 126.

### Machine Architecture

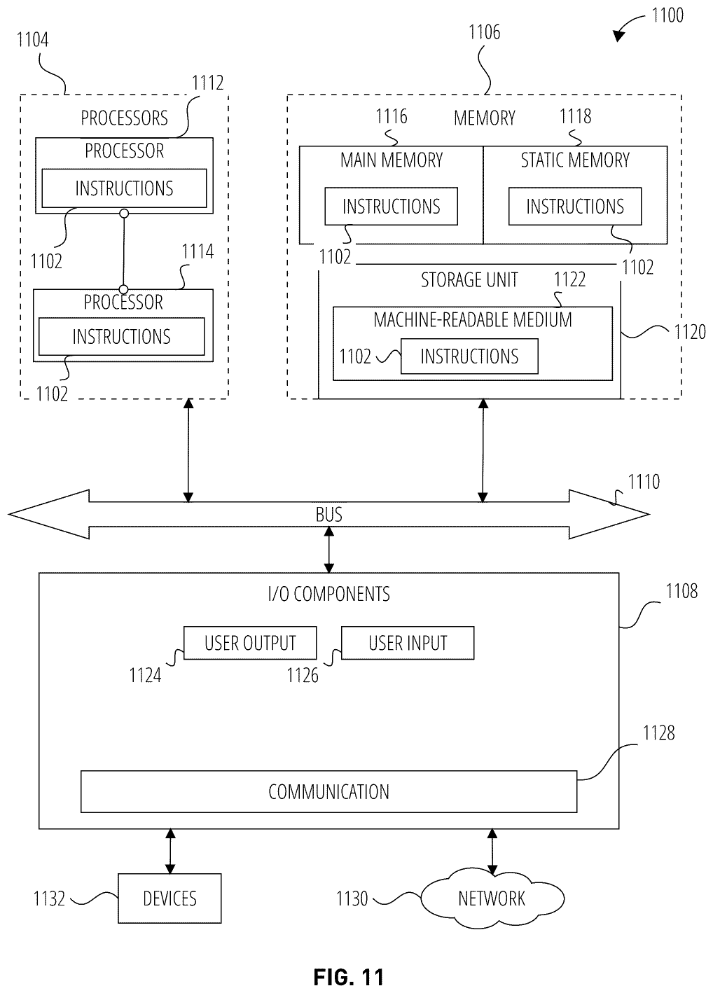

FIG. 11 is a diagrammatic representation of a machine 1100 within which instructions 1102 (e.g., software, a program, an application, an applet, an app, or other executable code) for causing the machine 1100 to perform any one or more of the methodologies discussed herein may be executed. For example, the instructions 1102 may cause the machine 1100 to execute any one or more of the methods described herein. In some examples, the machine 1100 can be the host device, as described above with reference to the system 500 of FIG. 5. In some examples, the machine 1100 can include an implement the system 500 and/or the display driver 504 described herein.

The instructions 1102 transform the general, non-programmed machine 1100 into a particular machine 1100 programmed to carry out the described and illustrated functions in the manner described. The machine 1100 may operate as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch, a pair of augmented reality glasses), a smart home device (e.g., a smart appliance), other smart devices, a web appliance, a network router, a network switch, a network bridge, or any machine capable of executing the instructions 1102, sequentially or otherwise, that specify actions to be taken by the machine 1100. Further, while a single machine 1100 is illustrated, the term “machine” shall also be taken to include a collection of machines that individually or jointly execute the instructions 1102 to perform any one or more of the methodologies discussed herein. In some examples, the machine 1100 may comprise both client and server systems, with certain operations of a particular method or algorithm being performed on the server-side and with certain operations of the particular method or algorithm being performed on the client-side.

The machine 1100 may include processors 1104, memory 1106, and input/output I/O components 1108, which may be configured to communicate with each other via a bus 1110. In an example, the processors 1104 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1112 and a processor 1114 that execute the instructions 1102. The term “processor” is intended to include multi-core processors that may comprise two or more independent processors (sometimes referred to as “cores”) that may execute instructions contemporaneously. Although FIG. 11 shows multiple processors 1104, the machine 1100 may include a single processor with a single-core, a single processor with multiple cores (e.g., a multi-core processor), multiple processors with a single core, multiple processors with multiples cores, or any combination thereof.

The memory 1106 includes a main memory 1116, a static memory 1118, and a storage unit 1120, both accessible to the processors 1104 via the bus 1110. The main memory 1106, the static memory 1118, and storage unit 1120 store the instructions 1102 embodying any one or more of the methodologies or functions described herein. The instructions 1102 may also reside, completely or partially, within the main memory 1116, within the static memory 1118, within machine-readable medium 1122 within the storage unit 1120, within at least one of the processors 1104 (e.g., within the processor's cache memory), or any suitable combination thereof, during execution thereof by the machine 1100.

The I/O components 1108 may include a wide variety of components to receive input, provide output, produce output, transmit information, exchange information, capture measurements, and so on. The specific I/O components 1108 that are included in a particular machine will depend on the type of machine. For example, portable machines such as mobile phones may include a touch input device or other such input mechanisms, while a headless server machine will likely not include such a touch input device. It will be appreciated that the I/O components 1108 may include many other components that are not shown in FIG. 11. In various examples, the I/O components 1108 may include user output components 1124 and user input components 1126. The user output components 1124 may include visual components (e.g., a display such as the display 506, a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1126 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

Communication may be implemented using a wide variety of technologies. The I/O components 1108 further include communication components 1128 operable to couple the machine 1100 to a network 1130 or devices 1132 via respective coupling or connections. For example, the communication components 1128 may include a network interface component or another suitable device to interface with the network 1130. In further examples, the communication components 1128 may include wired communication components, wireless communication components, cellular communication components, satellite communication, Near Field Communication (NFC) components, Bluetooth® components (e.g., Bluetooth® Low Energy), Wi-Fi® components, Zigbee, Ant+, and other communication components to provide communication via other modalities. The devices 1132 may be another machine or any of a wide variety of peripheral devices (e.g., a peripheral device coupled via a USB).

The various memories (e.g., main memory 1116, static memory 1118, and memory of the processors 1104) and storage unit 1120 may store one or more sets of instructions and data structures (e.g., software) embodying or used by any one or more of the methodologies or functions described herein. These instructions (e.g., the instructions 1102), when executed by processors 1104, cause various operations to implement the disclosed examples.

The instructions 1102 may be transmitted or received over the network 1130, using a transmission medium, via a network interface device (e.g., a network interface component included in the communication components 1128) and using any one of several well-known transfer protocols (e.g., hypertext transfer protocol (HTTP)). Similarly, the instructions 1102 may be transmitted or received using a transmission medium via a coupling (e.g., a peer-to-peer coupling) to the devices 1132.

### Conclusion

As described above, examples described herein may address one or more technical problems associated with driving a color sequential liquid crystal display, such as a color sequential LCoS display having an LCoS panel. In some examples, a long-ramp control scheme can be provided that adjusts ramp time and/or decay time for color sub frames based on the pixel intensity values of the current color sub frame and the previous color sub frame, to provide consistent image quality, high frame rates, high display brightness, and/or reduced visual artifacts. In some examples, the long-ramp control scheme can be calibrated to generate selection logic for selecting a start time for a color sub frame that achieves a close match to a baseline luminance for a given pixel intensity value. In some examples, the long-ramp control scheme can include the capability to drive the pixel using a pre-emphasis modulation pulse to further improve the degree of control over the pixel's luminance during a color sub frame.

Example 1 is a device comprising: a display driver configured to perform operations comprising: obtaining pixel intensity data for a pixel of a color sequential liquid crystal display, the pixel intensity data comprising: a pixel intensity value for a first color sub frame (CSF); and a pixel intensity value for a second CSF following the first CSF; applying selection logic to the pixel intensity data to select a start time for a modulation pulse to be applied to liquid crystal material of the pixel, the selection logic comprising: for a given pixel intensity value for the second CSF: in response to a first pixel intensity value for the first CSF, selecting a first start time from a plurality of predefined potential start times; and in response to a second pixel intensity value for the first CSF that is greater than the first pixel intensity value, selecting a second start time from the plurality of predefined potential start times, the second start time being later than the first start time; and driving the liquid crystal material of the pixel with a modulation pulse starting at the selected start time.

In Example 2, the subject matter of Example 1 includes, wherein: the pixel intensity values comprise grayscale values.

In Example 3, the subject matter of Examples 1-2 includes, wherein: the pixel intensity values are encoded as binary encodings; and the selection logic bases its selection of start time on no more than 4 most significant bits of the binary encoding of the pixel intensity value for the first CSF.

In Example 4, the subject matter of Examples 1-3 includes, wherein: each predefined potential start time of the plurality of predefined potential start times falls within a ramp start window of the second CSF; and the ramp start window ends no later than a start time of an illumination window of the second CSF during which an emitter illuminates the pixel.

In Example 5, the subject matter of Examples 1-4 includes, wherein: the selection logic bases its selection of the start time at least in part on the pixel intensity value for the second CSF.

In Example 6, the subject matter of Example 5 includes, wherein: the pixel intensity values are encoded as binary encodings; and the selection logic bases its selection of the start time on: no more than 4 most significant bits of the binary encoding of the pixel intensity value for the first CSF; and no more than 4 most significant bits of the binary encoding of the pixel intensity value for the second CSF.

In Example 7, the subject matter of Examples 5-6 includes, selecting an end time for the modulation pulse from a plurality of predetermined potential end times based on the pixel intensity value for the second CSF.

In Example 8, the subject matter of Example 7 includes, wherein: the selection logic selects the start time such that the driving of the liquid crystal material of the pixel with the modulation pulse results in a luminance of the pixel during the second CSF that is closer to a baseline luminance than a luminance resulting from the selection of any other predefined potential start time of the plurality of predefined potential start times.

In Example 9, the subject matter of Examples 1-8 includes, wherein: the color sequential liquid crystal display comprises: a liquid crystal on silicon (LCoS) panel; and a plurality of emitters, each emitter emitting light of a respective color during a respective CSF of a frame.

In Example 10, the subject matter of Examples 1-9 includes, wherein the pixel is a first pixel; the operations further comprising: driving a second pixel of the color sequential liquid crystal display during the second CSF using a modulation pulse having a different start time from the start time of the modulation pulse driving the first pixel.

In Example 11, the subject matter of Examples 1-10 includes, wherein: the plurality of predefined potential start times is based at least in part on a color of the second CSF.

In Example 12, the subject matter of Examples 1-11 includes, wherein: the selection logic comprises a look up table.

In Example 13, the subject matter of Examples 1-12 includes, determining, based on the pixel intensity value for the first CSF and the pixel intensity value for the second CSF, to further apply a pre-emphasis modulation pulse to the liquid crystal material of the pixel; and driving the liquid crystal material of the pixel with the pre-emphasis modulation pulse, the pre-emphasis modulation pulse ending before the selected start time.

Example 14 is a method for driving a color sequential liquid crystal display, comprising: obtaining pixel intensity data for a pixel of the color sequential liquid crystal display, the pixel intensity data comprising: a pixel intensity value for a first color sub frame (CSF); and a pixel intensity value for a second CSF following the first CSF; applying selection logic to the pixel intensity data to select a start time for a modulation pulse to be applied to liquid crystal material of the pixel, the selection logic comprising: for a given pixel intensity value for the second CSF: in response to a first pixel intensity value for the first CSF, selecting a first start time from a plurality of predefined potential start times; and in response to a second pixel intensity value for the first CSF that is greater than the first pixel intensity value, selecting a second start time from the plurality of predefined potential start times, the second start time being later than the first start time; and driving the liquid crystal material of the pixel with a modulation pulse starting at the selected start time.

In Example 15, the subject matter of Example 14 includes, wherein: the pixel intensity values comprise grayscale values.

In Example 16, the subject matter of Examples 14-15 includes, wherein: the pixel intensity values are encoded as binary encodings; and the selection logic bases its selection of start time on no more than 4 most significant bits of the binary encoding of the pixel intensity value for the first CSF.

In Example 17, the subject matter of Examples 14-16 includes, wherein: each predefined potential start time of the plurality of predefined potential start times falls within a ramp start window of the second CSF; and the ramp start window ends no later than a start time of an illumination window of the second CSF during which an emitter illuminates the pixel.

In Example 18, the subject matter of Examples 14-17 includes, wherein: the selection logic bases its selection of the start time at least in part on the pixel intensity value for the second CSF.

In Example 19, the subject matter of Example 18 includes, wherein: the pixel intensity values are encoded as binary encodings; and the selection logic bases its selection of the start time on: no more than 4 most significant bits of the binary encoding of the pixel intensity value for the first CSF; and no more than 4 most significant bits of the binary encoding of the pixel intensity value for the second CSF.

In Example 20, the subject matter of Examples 18-19 includes, selecting an end time for the modulation pulse from a plurality of predetermined potential end times based on the pixel intensity value for the second CSF.

In Example 21, the subject matter of Example 20 includes, wherein: the selection logic selects the start time such that the driving of the liquid crystal material of the pixel with the modulation pulse results in a luminance of the pixel during the second CSF that is closer to a baseline luminance than a luminance resulting from the selection of any other predefined potential start time of the plurality of predefined potential start times.

In Example 22, the subject matter of Examples 14-21 includes, wherein: the color sequential liquid crystal display comprises: a liquid crystal on silicon (LCoS) panel; and a plurality of emitters, each emitter emitting light of a respective color during a respective CSF of a frame.

In Example 23, the subject matter of Examples 14-22 includes, wherein the pixel is a first pixel; the method further comprising: driving a second pixel of the color sequential liquid crystal display using a modulation pulse having a different start time from the start time of the modulation pulse applied to the first pixel.

In Example 24, the subject matter of Examples 14-23 includes, wherein: the plurality of predefined potential start times is based at least in part on a color of the second CSF.

In Example 25, the subject matter of Examples 14-24 includes, wherein: the selection logic comprises a look up table.

In Example 26, the subject matter of Examples 14-25 includes, wherein the operations further comprise: determining, based on the pixel intensity value for the first CSF and the pixel intensity value for the second CSF, to further apply a pre-emphasis modulation pulse to the liquid crystal material of the pixel; and driving the liquid crystal material of the pixel with the pre-emphasis modulation pulse, the pre-emphasis modulation pulse ending before the selected start time.

Example 27 is a system comprising: a color sequential liquid crystal display comprising a plurality of pixels; and a display driver configured to perform operations comprising: obtaining pixel intensity data for a pixel of the plurality of pixels, the pixel intensity data comprising: a pixel intensity value for a first color sub frame (CSF); and a pixel intensity value for a second CSF following the first CSF; applying selection logic to the pixel intensity data to select a start time for a modulation pulse to be applied to liquid crystal material of the pixel, the selection logic comprising: for a given pixel intensity value for the second CSF: in response to a first pixel intensity value for the first CSF, selecting a first start time from a plurality of predefined potential start times; and in response to a second pixel intensity value for the first CSF that is greater than the first pixel intensity value, selecting a second start time from the plurality of predefined potential start times, the second start time being later than the first start time; and driving the liquid crystal material of the pixel with a modulation pulse starting at the selected start time.

Example 28 is at least one machine-readable medium including instructions that, when executed by processing circuitry, cause the processing circuitry to perform operations to implement of any of Examples 1-27.

Example 29 is an apparatus comprising means to implement of any of Examples 1-27.

Example 30 is a system to implement of any of Examples 1-27.

Example 31 is a method to implement of any of Examples 1-27.

It will be appreciated that the various aspects of the methods described above may be combined in various combination or sub-combinations.

Other technical features may be readily apparent to one skilled in the art from the figures, descriptions, and claims.

### Glossary

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Programming Interface (API)). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; USB flash drives; and CD-ROM and DVD-ROM disks. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A device comprising:
a display driver configured to perform operations comprising:
obtaining pixel intensity data for a pixel of a color sequential liquid crystal display, the pixel intensity data comprising:
a pixel intensity value for a first color sub frame (CSF); and
a pixel intensity value for a second CSF following the first CSF;
applying selection logic to the pixel intensity data to select a start time for a modulation pulse to be applied to liquid crystal material of the pixel, the selection logic comprising:
for a given pixel intensity value for the second CSF:
in response to a first pixel intensity value for the first CSF, selecting a first start time from a plurality of predefined potential start times; and
in response to a second pixel intensity value for the first CSF that is greater than the first pixel intensity value, selecting a second start time from the plurality of predefined potential start times, the second start time being later than the first start time; and
driving the liquid crystal material of the pixel with a modulation pulse starting at the selected start time.

2. The device of claim 1, wherein:
the pixel intensity values comprise grayscale values.

3. The device of claim 1, wherein:
the pixel intensity values are encoded as binary encodings; and
the selection logic bases its selection of start time on no more than 4 most significant bits of the binary encoding of the pixel intensity value for the first CSF.

4. The device of claim 1, wherein:
each predefined potential start time of the plurality of predefined potential start times falls within a ramp start window of the second CSF; and
the ramp start window ends no later than a start time of an illumination window of the second CSF during which an emitter illuminates the pixel.

5. The device of claim 1, wherein:
the selection logic bases its selection of the start time at least in part on the pixel intensity value for the second CSF.

6. The device of claim 5, wherein:
the pixel intensity values are encoded as binary encodings; and
the selection logic bases its selection of the start time on:
no more than 4 most significant bits of the binary encoding of the pixel intensity value for the first CSF; and
no more than 4 most significant bits of the binary encoding of the pixel intensity value for the second CSF.

7. The device of claim 5, wherein the operations further comprise:
selecting an end time for the modulation pulse from a plurality of predetermined potential end times based on the pixel intensity value for the second CSF.

8. The device of claim 7, wherein:
the selection logic selects the start time such that the driving of the liquid crystal material of the pixel with the modulation pulse results in a luminance of the pixel during the second CSF that is closer to a baseline luminance than a luminance resulting from the selection of any other predefined potential start time of the plurality of predefined potential start times.

9. The device of claim 1, wherein:
the color sequential liquid crystal display comprises:
a liquid crystal on silicon (LCoS) panel; and
a plurality of emitters, each emitter emitting light of a respective color during a respective CSF of a frame.

10. The device of claim 1,
wherein the pixel is a first pixel; and
the operations further comprise:
driving a second pixel of the color sequential liquid crystal display during the second CSF using a modulation pulse having a different start time from the start time of the modulation pulse driving the first pixel.

11. The device of claim 1, wherein:
the plurality of predefined potential start times is based at least in part on a color of the second CSF.

12. The device of claim 1, wherein:
the selection logic comprises a look up table.

13. The device of claim 1, wherein the operations further comprise:
determining, based on the pixel intensity value for the first CSF and the pixel intensity value for the second CSF, to further apply a pre-emphasis modulation pulse to the liquid crystal material of the pixel; and
driving the liquid crystal material of the pixel with the pre-emphasis modulation pulse, the pre-emphasis modulation pulse ending before the selected start time.

14. A method for driving a color sequential liquid crystal display, comprising:
obtaining pixel intensity data for a pixel of the color sequential liquid crystal display, the pixel intensity data comprising:
a pixel intensity value for a first color sub frame (CSF); and
a pixel intensity value for a second CSF following the first CSF;
applying selection logic to the pixel intensity data to select a start time for a modulation pulse to be applied to liquid crystal material of the pixel, the selection logic comprising:
for a given pixel intensity value for the second CSF:
in response to a first pixel intensity value for the first CSF, selecting a first start time from a plurality of predefined potential start times; and
in response to a second pixel intensity value for the first CSF that is greater than the first pixel intensity value, selecting a second start time from the plurality of predefined potential start times, the second start time being later than the first start time; and
driving the liquid crystal material of the pixel with a modulation pulse starting at the selected start time.

15. The method of claim 14, wherein:
the pixel intensity values comprise grayscale values.

16. The method of claim 14, wherein:
the pixel intensity values are encoded as binary encodings; and
the selection logic bases its selection of start time on no more than 4 most significant bits of the binary encoding of the pixel intensity value for the first CSF.

17. The method of claim 14, wherein:
each predefined potential start time of the plurality of predefined potential start times falls within a ramp start window of the second CSF; and
the ramp start window ends no later than a start time of an illumination window of the second CSF during which an emitter illuminates the pixel.

18. The method of claim 14, wherein:
the selection logic bases its selection of the start time at least in part on the pixel intensity value for the second CSF.

19. The method of claim 18, wherein:
the pixel intensity values are encoded as binary encodings; and
the selection logic bases its selection of the start time on:
no more than 4 most significant bits of the binary encoding of the pixel intensity value for the first CSF; and
no more than 4 most significant bits of the binary encoding of the pixel intensity value for the second CSF.

20. A system comprising:
a color sequential liquid crystal display comprising a plurality of pixels; and
a display driver configured to perform operations comprising:
obtaining pixel intensity data for a pixel of the plurality of pixels, the pixel intensity data comprising:
a pixel intensity value for a first color sub frame (CSF); and
a pixel intensity value for a second CSF following the first CSF;
applying selection logic to the pixel intensity data to select a start time for a modulation pulse to be applied to liquid crystal material of the pixel, the selection logic comprising:
for a given pixel intensity value for the second CSF:
in response to a first pixel intensity value for the first CSF, selecting a first start time from a plurality of predefined potential start times; and
in response to a second pixel intensity value for the first CSF that is greater than the first pixel intensity value, selecting a second start time from the plurality of predefined potential start times, the second start time being later than the first start time; and
driving the liquid crystal material of the pixel with a modulation pulse starting at the selected start time.
